(19) United States
(12) Patent Application Publication
(10) Pub. No.: US 2018/0299472 A1
(43) Pub. Date: Oct. 18, 2018

(54) AUTOMATED INSPECTION DEVICE FOR TESTING SPECIMENS AND METHOD OF USE THEREOF

(71) Applicant: Qing-Dong LING, Taipei City (TW)

(72) Inventor: Qing-Dong LING, Taipei City (TW)

(21) Appl. No.: 15/953,232

(22) Filed: Apr. 13, 2018

Related U.S. Application Data
(60) Provisional application No. 62/485,148, filed on Apr. 13, 2017.

(51) Int. Cl. G01N 35/00

(52) U.S. Cl. CPC G01N 35/00732; G01N 2035/00742; G01N 2035/00752

(57) ABSTRACT

An automated inspection device for testing specimens contained in reaction tubes with reagents contained in reagent tubes. The automated inspection device is electrically connected to a control system and includes a platform for supporting the reaction tubes and the reagent tubes. A mobile arm is electrically connected to the control system and is movable along the platform under control of the control system. A probing head connected to the mobile attic and is movable in conjunction with the mobile arm. A detector is disposed on the probing head and configured to detect specimen identification labels attached on the reaction tubes and reagent identification labels attached on the reagent tubes, and to locate each of the reaction tubes and reagent tubes and to allow the probing head to automatically get the reagents to corresponding specimens for test.

### RELATED APPLICATIONS

This application claims priority benefit of U.S. Provisional Patent Application No. 62/485,148 filed Apr. 13, 2017, of which is hereby incorporated by reference in its entirety.

### FIELD

The present invention relates to an inspection device, and particularly to an automated inspection device for testing specimens and a method of use thereof.

### RELATED ART

As is well known, either biochemical experiments or gene experiments are required to collect specimens for testing. For example, in medical institutions or research institutions, specimens are obtained by drawing blood from subjects. The blood specimens are placed in reaction tubes and corresponding reagents are added according to different types of tests.

Conventional methods of testing specimens for biochemical experiments or gene experiments are performed manually using testing experiment devices. Specifically, prior to testing specimens, it is required to carry out identification of the specimens and the reagents. Referring to FIG. 1, a schematic view of a conventional inspection device for testing specimens is shown. During the process of identification, each of the specimens 90 is placed on a predetermined position of a conveying track 91. The conveying track 91 is configured with multiple exit tracks 93, and each of the exit tracks 93 is connected to an experimental area 94 for a specific test. A prober 92 is fixedly disposed on one side of the conveying track 91. The specimens 90 are conveyed via the conveying track 91 to pass by the fixed prober 92 one by one, so that the fixed prober 92 can identify each of the specimens 90 and determine which of the exit tracks 93 is designated for conveying corresponding specimens 90 to the experimental area 94 for automated testing. In other words, the specimens 90 on the conveying track 91 after being identified are automatically conveyed to designated exit tracks 93. However, because the specimens 90 are manually placed on the conveying track 91 according to predetermined positions, it is highly likely for the specimens 90 to be mistakenly placed. Once the specimens 90 are placed at an incorrect position or direction, the fixed prober 92 cannot identify the specimens 90, or the specimens 90 may be dispatched to an incorrect exit track 93 for a wrong test. Even worse, wrong positions of the specimens 90 may cause the system to cease operating during the process of identification. Consequently, an invalid experimental result is generated, and testing must be carried out again. However, re-experiments increase cost expenditure. Furthermore, a large space is occupied by the conveying track 91 having multiple exit tracks 93, and the multiple experimental areas 94, and thus also results in an increase of management cost and hardware building costs of a laboratory.

### SUMMARY

Accordingly, an object of the present invention is to provide an automated inspection device for automatically and accurately testing specimens, avoiding mistakenly test by manually operation, and saving the use of space for test.

To achieve the above-mentioned object, the automated inspection device, for testing specimens contained in reaction tubes for being tested with reagents contained in reagent tubes, is electrically connected to a control system, and the automated inspection device comprises a platform for supporting the reaction tubes and the reagent tubes; a mobile arm electrically connected to the control system and movable along the platform under control of the control system; a probing head connected to the mobile arm and movable in conjunction with the mobile arm; and a detector disposed on the probing head and configured to detect specimen identification labels attached on the reaction tubes and reagent identification labels attached on the reagent tubes, and to locate each of the reaction tubes and reagent tubes for allowing the probing head to automatically get the reagents to corresponding specimens for test.

In one aspect of the present invention, the platform is defined with a first area and a second area, the reaction tubes and the reagent tubes are respectively disposed on the first area and the second area, the control system is input with predetermined platform layout information about locations of the first area and the second area on the platform, thereby to guide the mobile arm to move to the first area and the second area.

In another aspect of the present invention, the control system comprises a process unit, the detector generating and transmitting detection data to the process unit after detecting each of the specimen identification labels and the reagent identification labels, and the process unit is capable of analyzing and processing the detection data and generating a digital command for triggering the probing head to automatically get the reagents to corresponding specimens for test.

In another aspect of the present invention, the probing head is movable on the mobile arm to get one of the reagent tubes up and moves in conjunction with the mobile arm to a corresponding reaction tube, and to inject the reagent into the specimen.

In another aspect of the present invention, each of the specimen identification labels contains corresponding test information indicating which of the reagents is to be utilized, and the test information of some of the specimen identification labels are different to that of the other specimen identification labels, so that different types of tests are capable of being performed on the platform.

In another aspect of the present invention, each of the specimen identification labels and the reagent identification labels is provided with a radio frequency identification (RFID) chip, a near field communication (NFC) chip, a quick response (QR) code, or a barcode.

In accordance with the automated inspection device of the present invention, a method of using the automated inspection device for testing specimens, the specimens contained in reaction tubes for being tested with reagents contained in reagent tubes, the automated inspection device electrically connected to a control system, the method comprising steps of: providing a platform for supporting the reaction tubes and the reagent tubes; providing a mobile arm electrically connected to the control system, the mobile arm movable to the platform under control of the control system; providing a probing head connected to the mobile arm and movable in conjunction with the mobile arm; providing a detector disposed on the probing head; operating the control system to trigger the mobile arm to move along the platform, the detector moving in conjunction with the mobile arm to detect each of the specimen identification labels attached on the reaction tubes and each of reagent identification labels attached on the reagent tubes, and to locate each of the reaction tubes and reagent tubes; and utilizing the probing head to get the reagents automatically after the reaction tubes and reagent tubes are located, and the probing head moving in conjunction with the mobile arm to corresponding reaction tubes to perform a test of the reagents and the specimens.

The automated inspection device of the present invention utilizes the platform to hold the reaction tubes and the reagent tubes on the same and small area, thereby to address the drawbacks of the conventional inspection system that requires a large space and a complex structure resulting in a higher cost and difficulties of management; furthermore, the detector cooperating with the mobile arm and the probing head is capable of automatically detecting and locating the specimen identification labels and the identification labels to facilitate the test of the specimens and the reagents, thereby to prevent the specimens from being mistakenly tested with the reagents because of manually identification of locations of the reaction tubes and the reagent tubes, and to avoid increasing the cost of performing the test again.

### BRIEF DESCRIPTION OF DRAWINGS

FIG. 1 is a schematic view showing a conventional inspection device for testing specimens.

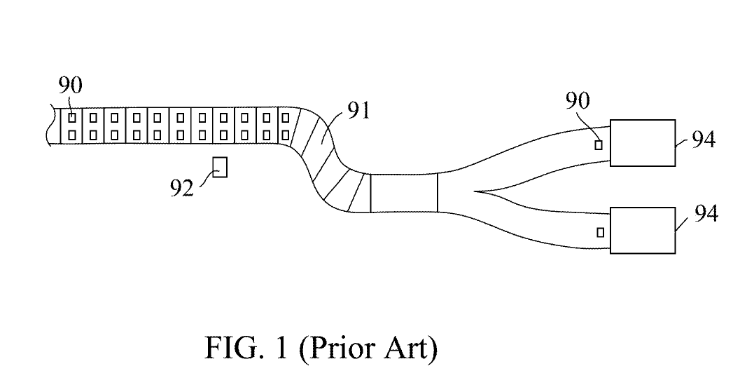

FIG. 2 is a schematic top plan view showing an automated inspection device for testing specimens of the present invention.

FIG. 3 is a schematic side view showing the automated inspection device of FIG. 2.

FIG. 4 is a schematic view showing a mobile arm moving to detect specimen identification labels of the present invention.

FIG. 5 is a schematic view showing a mobile arm moving to detect reagent identification labels of the present invention.

FIG. 6 is a schematic perspective view showing a probing head of the present invention is getting a reagent tube.

FIG. 7 is a schematic perspective view showing the probing head is injecting a reagent into a reaction tube for test.

FIG. 8 is a flowchart of a method of using the automated inspection device for testing specimens of the present disclosure.

### DESCRIPTION OF EMBODIMENTS

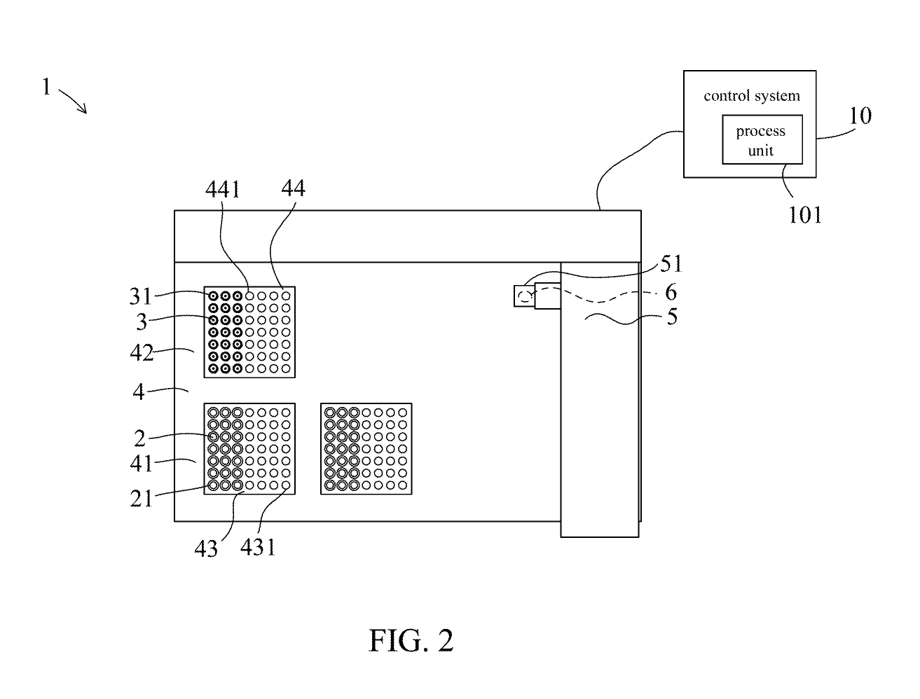

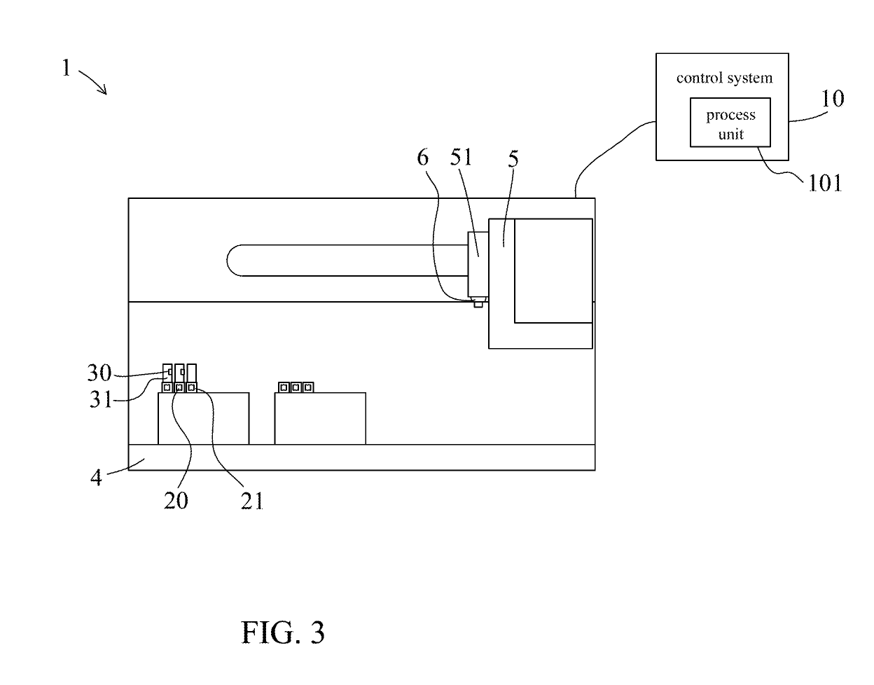

The present invention relates to an automated inspection device for testing specimens in either a biochemical experiment or a genetic experiment. FIG. 2 shows a schematic top plan view of an automated inspection device of the present invention and FIG. 3 shows a side view of FIG. 2. The automated inspection device 1 is electrically connected to a control system 10 comprising a process unit 101. Specimens 2 are contained in reaction tubes 21 and reagents 3 are contained in reagent tubes 31. The automated inspection device 1 comprises a platform 4, a plurality of specimen identification labels 20, a plurality of reagent identification labels 30 (as shown in FIG. 3), a mobile arm 5, and a detector 6.

The platform 4 comprises a first area 41 and a second area 42. In the preferable embodiment, the platform 4 is covered by a transparent case (not shown) to prevent testing processes from being affected by external objects. At least a first tray 43 and a second tray 44 are provided on the platform 4 and are removable from the platform 4. Specially, the first tray 43 has multiple supporting holes 431 arranged in a layout for supporting the reaction tubes 21 and is placed on the first area 41. The second tray 44 has multiple holding holes 441 arranged in a layout for holding the reagent tubes 31 and is placed on the second area 42. The control system 10 is input with predetermined platform layout information about locations of the first area 41 and the second area 42 on the platform 4. The layout of the supporting holes 431 and the layout of the holding holes 441 are input in advance in the control system 10. Of particular note is that the supporting holes 431 and the holding holes 441 taken up by the reaction tubes 21 and the reagent tubes 31 are marked in the layout of the supporting holes 431 and the layout of the holding holes 441. In this manner, the mobile arm 5 is capable of being guided to move to the first area 41 and the second area 42 based on the platform layout information, and the time of locating the reaction tubes 21 and the reagent tubes 31 can be shortened.

In order to optimize efficiency of the automated inspection device 1 by testing as more as the specimens 2 in a limited area, the reaction tubes 21 are spaced apart from each other at a distance equal to or less than one centimeter, and the reagent tubes 31 are spaced apart from each other at a distance equal to or less than one centimeter.

Referring to FIG. 3, a plurality of specimen identification labels 20 are attached to corresponding reaction tubes 21. Each of the specimen identification labels 20 contains corresponding test information indicating which of the reagents 3 is to be utilized. In one embodiment, each specimen identification label 20 also contains a subject's basic identification data, such as the subject's age and gender. A plurality of reagent identification labels 30 are respectively attached to the reagent tubes 31, and each of the reagent identification labels 30 contains corresponding reagent information which indicates information about a test type and a use of the test type. Particularly, each of the specimen identification labels 20 and the reagent identification labels 30 is provided with a radio frequency identification (RFID) chip, a near field communication (NFC) chip, a quick response (QR) code, or a barcode. In this embodiment, the specimen identification labels 20 and the reagent identification labels 30 are RFID labels.

Further referring to FIG. 3, the mobile arm 5 is electrically connected to the control system 10 and disposed above the platform 4. A probing head 51 is connected to mobile arm 5 and is movably on the mobile arm 5, which is capable of moving backward and forward above the platform 4. The probing head 52 is capable of moving up and down on the mobile arm 5. A detector 6 is disposed on a bottom of the probing head 51 for detecting the specimen identification labels 20 and the reagent identification labels 30 through RFID communication.

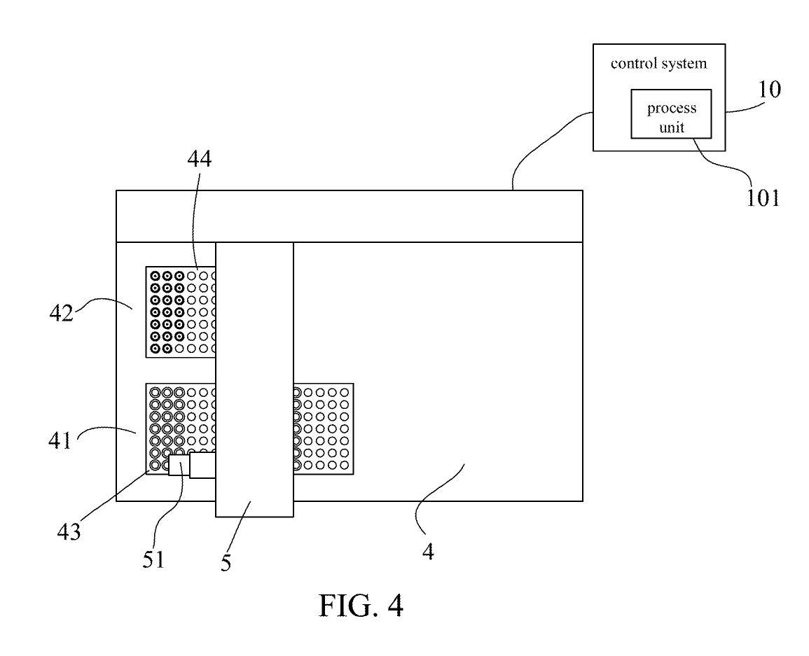

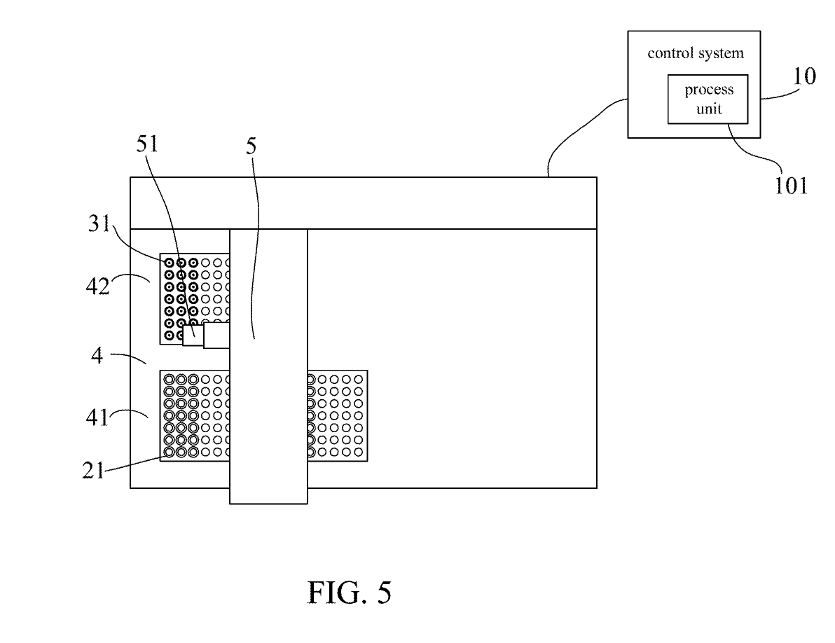

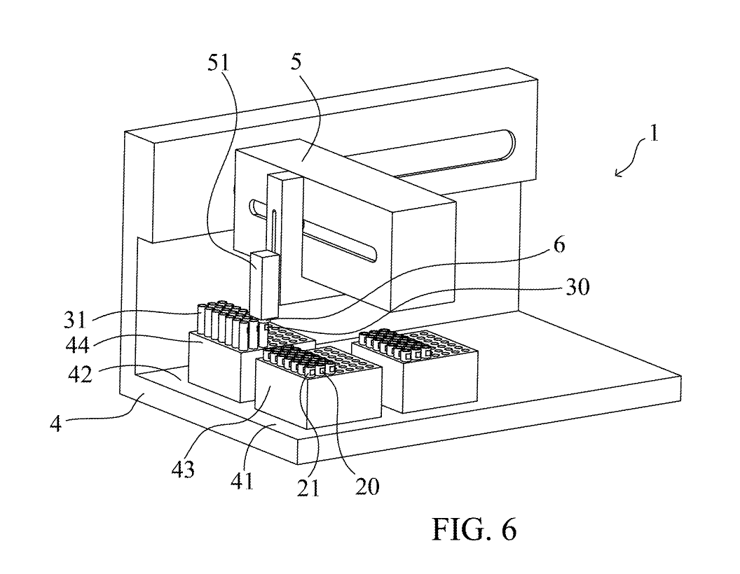

Referring to FIGS. 4 to 7, in use of the automated inspection device 1, the mobile arm 5 is automatically movable to the first area 41 area and the second area 42, under control of the control system 10 after the reaction tubes 21 and the reagent tubes 31 are placed in position on the platform 4. In the preferable embodiment, the mobile arm 5 first moves to the first area 41 to detect the specimen identification labels 20 of the reaction tubes 21 one by one. Specifically, the probing head 52 moves downward to come close to one of the reaction tubes 21, thereby to allow the detector 6 to detect the one of the reaction tubes 21 through RFID communication. Then, the probing head 52 moves upward and along with the move of the mobile arm 5 to a next reaction tube 21, and one on one till all the specimen identification labels 20 are being detected. After completion of the detection of the specimen identification labels 20 on the first area 41, the mobile arm 5 automatically continues moving to the second area 42 for detecting the reagent identification labels 30 of the reagent tubes 31 one by one.

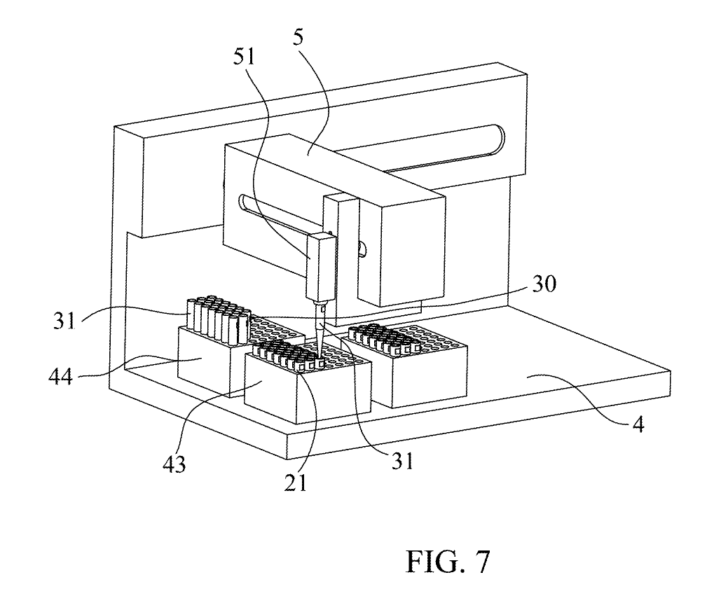

The detector 6 concurrently generates and transmits detection data to the process unit 101 as soon as each of the specimen identification labels 20 and the reagent identification labels 30 is detected. The process unit 101 is utilized to analyze and process the detection data, and therefore to match the location of the reaction tubes 21 with that of corresponding reagent tubes 31, as well as to identify which of the reagents 3 is to be used on a corresponding specimen 2. The process unit 101 generates a digital command, based on the detection data, for triggering the probing head 51 to automatically get the reagents 3 to corresponding specimens 2 for test. Specifically, the probing head 51 is moving to get one of the reagent tubes 31 up and moves in conjunction with the mobile arm 5 to a corresponding reaction tube 21, thereby to inject the reagent 3 into the specimen 2 for test (as shown in FIG. 7).

The test information of some of the specimen identification labels 20 are different to that of the other specimen identification labels 20, and the reagent information of some of the reagent identification labels 30 are different to that of the other reagent identification labels 30, so that different types of tests are capable of being performed on the platform 4, which efficiently improve the testing productivity.

Accordingly, the automated inspection device 1 of the present invention utilizes the detector 6 moving in conjunction with the mobile arm 5 to detect specimen identification label 20 and reagent identification label 30 through RFID communication, thereby to accurately rapidly locate and match each of the reaction tubes 21 and the reagent tubes 31, and complete the test of the specimens 2 and the reagents 3 all through a nonstop and automated process.

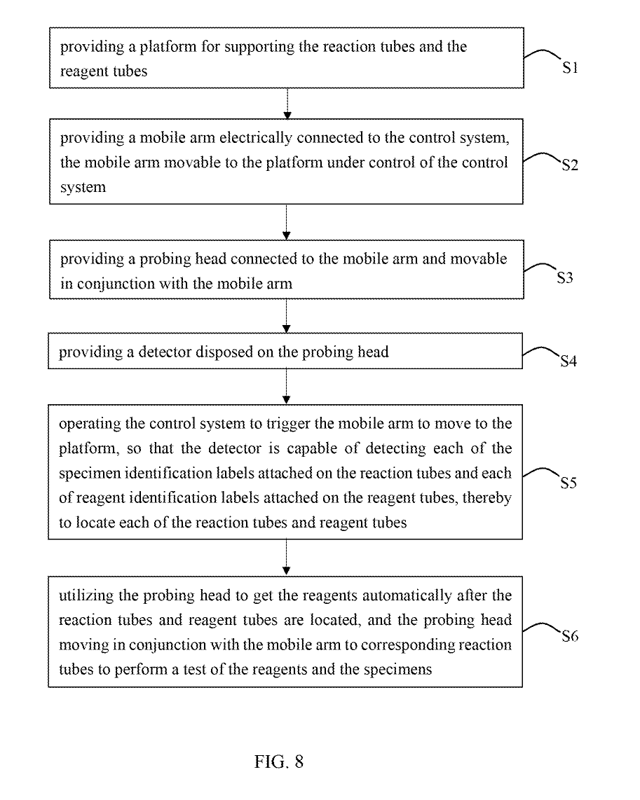

Referring to FIG. 8, in accordance with the automated inspection device 1 as described above, a method of using the automated inspection device 1 of the present invention comprises steps as follows: S1: providing a platform 4 for supporting the reaction tubes 21 and the reagent tubes 31; S2: providing a mobile arm 5 electrically connected to the control system 10, the mobile arm 5 movable to the platform 4 under control of the control system; S3: providing a probing head 51 connected to the mobile arm 5 and movable in conjunction with the mobile arm 5; S4: providing a detector 6 disposed on the probing head 51; S5: operating the control system 10 to trigger the mobile arm 5 to move to the platform 4, so that the detector 6 is capable of detecting each of the specimen identification labels 20 attached on the reaction tubes 21 and each of reagent identification labels 30 attached on the reagent tubes 31, thereby to locate each of the reaction tubes 21 and reagent tubes 31; and S6: utilizing the probing head 51 to get the reagents 3 automatically after the reaction tubes 21 and reagent tubes 31 are located, and the probing head 51 moving in conjunction with the mobile arm 5 to corresponding reaction tubes 21 to perform a test of the reagents 3 and the specimens 2.

The platform 4 is defined with a first area 41 and a second area 42. A first tray 43 is placed on the first area 41 and has multiple supporting holes 431 arranged in a layout for supporting the reaction tubes 21. A second tray 44 is placed on the second area 42 and has multiple holding holes 441 arranged in a layout for holding the reagent tubes 31. Prior to operating the control system 10 to trigger the mobile arm 5, the control system 10 is input with predetermined platform layout information about locations of the first area 41 and the second area 42, the layout of the supporting holes 431, and the layout of the holding holes 441, so that the mobile arm 5 is capable of being guided to the reaction tubes 21 and the reagent tubes 31.

Accordingly, the automated inspection device of the present invention utilizes the platform 4 to hold the reaction tubes 21 and the reagent tubes 31 on the same and small area, thereby to address drawbacks of the conventional inspection system that requires a large space and a complex structure resulting in a higher cost and difficulties of management. Furthermore, the detector 6 cooperating with the mobile arm 5 and the probing head 51 is capable of automatically detecting and locating the specimen identification labels 20 and the identification labels 30 to facilitate the test of the specimens 2 and the reagents 3, thereby to prevent the specimens 2 from being mistakenly tested with the reagents 3 because of manually identification of locations of the reaction tubes and the reagent tubes, and to avoid increasing the cost of performing the test again.

It is understood that the invention may be embodied in other forms within the scope of the claims. Thus the present examples and embodiments are to be considered in all respects as illustrative, and not restrictive, of the invention defined by the claims.

What is claimed is:

1. An automated inspection device for testing specimens, the specimens contained in reaction tubes for being tested with reagents contained in reagent tubes, the automated inspection device electrically connected to a control system and comprising:
a platform for supporting the reaction tubes and the reagent tubes;
a mobile arm electrically connected to the control system and movable along the platform under control of the control system;
a probing head connected to the mobile arm and movable in conjunction with the mobile arm; and
a detector disposed on the probing head and configured to detect specimen identification labels attached on the reaction tubes and reagent identification labels attached on the reagent tubes, and to locate each of the reaction tubes and reagent tubes for allowing the probing head to automatically get the reagents to corresponding specimens for test.

2. The automated inspection device for testing specimens of claim 1, wherein the platform is defined with a first area and a second area, the reaction tubes and the reagent tubes are disposed on the first area and the second area, respectively; the control system is input with predetermined platform layout information about locations of the first area and the second area on the platform for guiding the mobile arm to move to the first area and the second area.

3. The automated inspection device for testing specimens of claim 2, wherein the platform further comprises a first tray placed on the first area, and the first tray has multiple supporting holes arranged in a layout for supporting the reaction tubes, and the layout of the supporting holes is further provided in the control system.

4. The automated inspection device for testing specimens of claim 2, wherein the platform further comprises a second tray placed on the second area, and the second tray has multiple holding holes arranged in a layout for holding the reagent tubes, and the layout of the holding holes is further provided in the control system.

5. The automated inspection device for testing specimens of claim 1, wherein the control system comprises a process unit, the detector generating and transmitting detection data to the process unit after detecting each of the specimen identification labels and the reagent identification labels, and the process unit is capable of analyzing and processing the detection data and generating a digital command for triggering the probing head to automatically get the reagents to corresponding specimens for test.

6. The automated inspection device for testing specimens of claim 1, wherein the probing head is movable on the mobile arm to get one of the reagent tubes up and moves in conjunction with the mobile arm to a corresponding reaction tube, and further to inject the reagent into the specimen.

7. The automated inspection device for testing specimens of claim 1, wherein the reaction tubes are spaced apart from each other at a distance equal to or less than one centimeter.

8. The automated inspection device for testing specimens of claim 1, wherein the reagent tubes are spaced apart from each other at a distance equal to or less than one centimeter.

9. The automated inspection device for testing specimens of claim 1, wherein each of the specimen identification labels contains corresponding test information indicating which of the reagents is to be utilized, and the test information of some of the specimen identification labels are different to the test information of the other specimen identification labels, so that different types of tests are capable of being performed on the platform.

10. The automated inspection device for testing specimens of claim 1, wherein each of the specimen identification labels and the reagent identification labels is provided with a radio frequency identification (RFID) chip, a near field communication (NFC) chip, a quick response (QR) code, or a barcode.

11. A method of using an automated inspection device for testing specimens, the specimens contained in reaction tubes for being tested with reagents contained in reagent tubes, the automated inspection device electrically connected to a control system, the method comprising steps of:
providing a platform for supporting the reaction tubes and the reagent tubes;
providing a mobile arm electrically connected to the control system, the mobile arm movable to the platform under control of the control system;
providing a probing head connected to the mobile arm and movable in conjunction with the mobile arm;
providing a detector disposed on the probing head;
operating the control system to trigger the mobile arm to move along the platform, the detector moving in conjunction with the mobile arm to detect each of the specimen identification labels attached on the reaction tubes and each of reagent identification labels attached on the reagent tubes, and to locate each of the reaction tubes and reagent tubes; and
utilizing the probing head to get the reagents automatically after the reaction tubes and reagent tubes are located, and the probing head moving in conjunction with the mobile arm to corresponding reaction tubes to perform a test of the reagents and the specimens.

12. The method of claim 11, wherein the platform is defined with a first area and a second area, the reaction tubes disposed on the first area, the reagent tubes disposed on the second area, the control system is input with predetermined platform layout information about locations of the first area and the second area on the platform for guiding the mobile arm to move to the first area and the second area.

13. The method of claim 12, wherein the platform further comprises a first tray placed on the first area, and the first tray has multiple supporting holes arranged in a layout for supporting the reaction tubes, and the layout of the supporting holes is further provided in the control system prior to operating the control system to trigger the mobile arm.

14. The method of claim 12, wherein the platform further comprises a second tray placed on the second area, and the second tray has multiple holding holes arranged in a layout for holding the reagent tubes, and the layout of the holding holes is further provided in the control system prior to operating the control system to trigger the mobile arm.

15. The method of claim 11, wherein the control system comprises a process unit, the detector generating and transmitting detection data to the process unit after detection of each of the specimen identification labels and the reagent identification labels, and the process unit is capable of analyzing and processing the detection data and generating a digital command for triggering the probing head to get the reagents and move in conjunction with the mobile arm to corresponding reaction tubes to perform a test of the reagents and the specimens.

16. The method of claim 11, wherein the probing head is movable on the mobile arm to get one of the reagent tubes up and moves in conjunction with the mobile arm to a corresponding reaction tube, and further to inject the reagent into the specimen.

17. The method of claim 11, wherein each of the specimen identification labels and the reagent identification labels is provided with a radio frequency identification (RFID) chip, a near field communication (NFC) chip, a quick response (QR) code, or a barcode.

18. The method of claim 11, wherein each of the specimen identification labels contains corresponding test information indicating which of the reagents is to be utilized, and the test information of some of the specimen identification labels are different to the test information of the other specimen identification labels, so that different types of tests are capable of being performed on the platform.
